(19) United States
(12) Patent Application Publication
(10) Pub. No.: US 2021/0261312 A1
(43) Pub. Date: Aug. 26, 2021

(54) Compostable Packaging

(71) Applicants: Anuradha Andy De Silva, Rancho Palos Verdes, CA (US); Shehan James, Los Angeles, CA (US); Dinesh Weerasekera, Fullerton, CA (US)

(72) Inventors: Anuradha Andy De Silva, Rancho Palos Verdes, CA (US); Shehan James, Los Angeles, CA (US); Dinesh Weerasekera, Fullerton, CA (US)

(21) Appl. No.: 16/799,174

(22) Filed: Feb. 24, 2020

(51) Int. Cl. B65D 65/46; B65D 85/72; B65D 8/00

(52) U.S. Cl. CPC B65D 65/466; A45D 40/00; B65D 9/02; B65D 85/72

(57) ABSTRACT

A compostable packaging has 50-70% bamboo fiber, 20-40% sugarcane, and 5-15% wood fiber. Packaging of this material is adapted for use with a variety of materials, and in particular granular shampoo and related cosmetics (e.g. shampoo, conditioner, body wash). In another embodiment, the packaging is adapted for use with medications (e.g. prescription pills, topical medications, vitamins), condiments (e.g. ketchup, mustard, teriyaki, mayonnaise), or other similar materials.

### BACKGROUND OF THE INVENTION

### Field of the Invention

This invention relates generally to compostable packaging, and more particularly to a paper based compostable packaging adapted to contain a shampoo product.

### Description of Related Art

A large number of products are packaged in plastic containers, due their low costs and ease of manufacture. However, environmental concerns are a growing factor, and there is a growing need for paper-based packaging that is completely free of plastic.

### SUMMARY OF THE INVENTION

The present invention teaches certain benefits in construction and use which give rise to the objectives described below.

The present invention provides a compostable packaging comprising 50-70% bamboo fiber, 20-40% sugarcane, and 5-15% wood fiber. Packaging of this material is adapted for use with a variety of materials, and in particular granular shampoo and related cosmetics (e.g. shampoo, conditioner, body wash, lip balm, skincare, makeup, foundation).

In another embodiment, the packaging is adapted for use with medications (e.g. prescription pills, topical medications, vitamins), condiments (e.g. ketchup, mustard, teriyaki, mayonnaise), or other materials deemed suitable by those skilled in the art, given the teachings of the present invention.

A primary objective of the present invention is to provide a compostable packaging having advantages not taught by the prior art.

Another objective is to provide a compostable packaging which is paper-based.

A further objective is to provide a compostable packaging adapted to contain a granular shampoo product.

A further objective is to provide a compostable packaging adapted to contain any form of cosmetics (e.g. shampoo, conditioner, body wash, lip balm, skincare, makeup, foundation), medication (e.g. prescription pills, topical medications, vitamins), condiments (e.g. ketchup, mustard, teriyaki, mayonnaise), or other materials deemed suitable by those skilled in the art, given the teachings of the present invention.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention. In such drawings:

FIG. 1 is an exploded perspective view of a compostable packaging according to one embodiment of the present invention and containing a granular shampoo product; and

FIG. 2 is an assembled perspective view thereof.

### DETAILED DESCRIPTION OF THE INVENTION

The above-described drawing figures illustrate the invention, a paper-based compostable packaging 10 for containing a variety of products, as discussed in greater detail below.

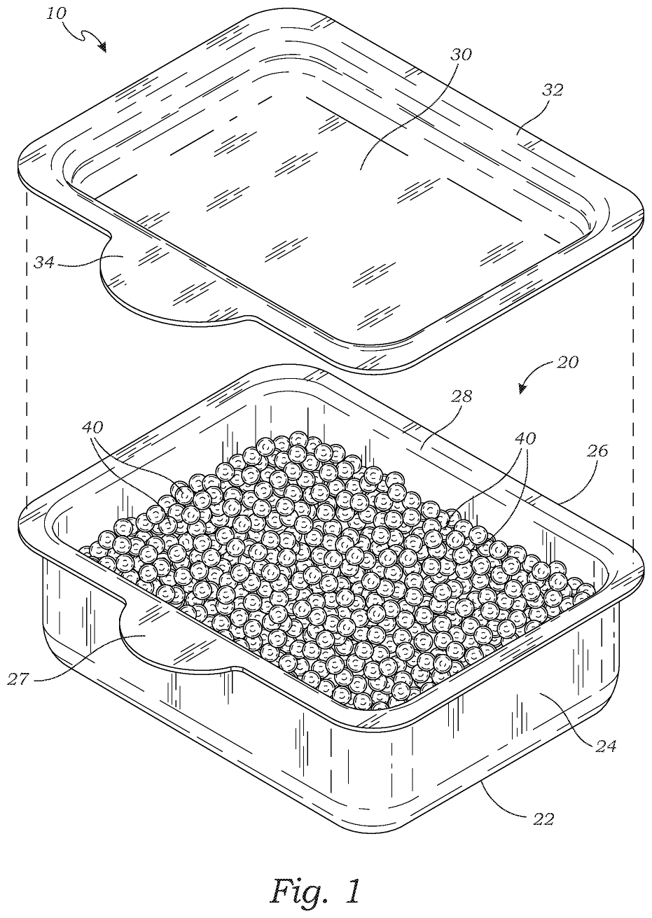

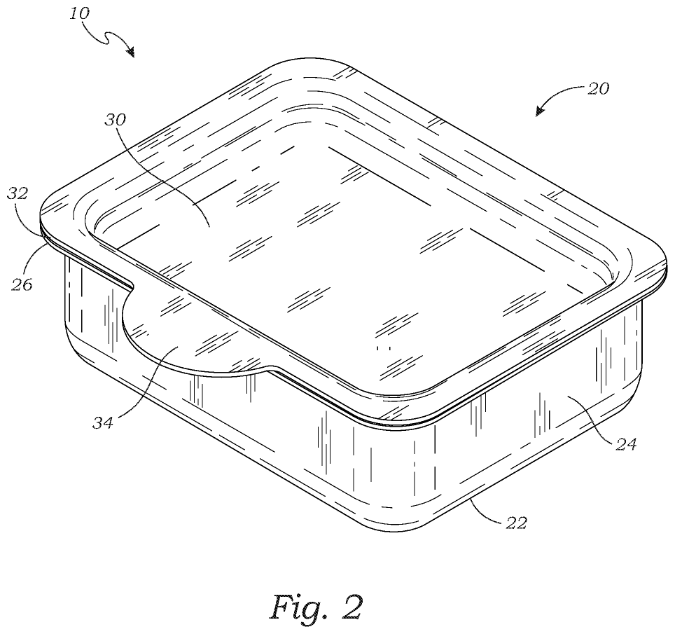

FIG. 1 is an exploded perspective view of the compostable packaging 10 according to one embodiment of the present invention and containing a granular shampoo composition 40, and FIG. 2 is an assembled perspective view thereof. As shown in FIGS. 1-2, the compostable packaging 10 includes a main body 20 having a base 22 and an upwardly extending wall 24 that extends to a body perimeter 26 that defines an opening 28. The compostable packaging 10 further includes a lid 30 that extends to an outer perimeter 32, wherein the outer perimeter 32 sealingly engages the body perimeter 26 of the main body 20 for closing the opening 28. The outer perimeter 32 may be raised slightly, such that the lid 30 extends into the main body 20 when covering the opening 28.

In this embodiment, the body perimeter 26 and the outer perimeter 32 each includes flanges which facilitate a proper engagement. Contours may be provide a snap/friction fit, and/or the perimeters 26 and 32 may be welded, bonded, glued, or otherwise sealed, or they may be left separate and rely on a frictional engagement, or other form of connection known in the art. In this embodiment, the body perimeter 26 and the outer perimeter 32 each include tabs 27 and 34, respectively, for facilitating opening of the compostable packaging 10. However, in other embodiments, other means of opening the compostable packaging 10 may be implemented, e.g., a textured portion to provide friction, a clip, hook, etc. In this embodiment, the compostable packaging 10 is in a generally rectangular cuboid shape, but in other embodiments, the compostable packaging 10 may be provided in alternative shapes (e.g., round/spherical, elongate, hexagonal, or any other shapes desired by one skilled in the art).

The compostable packaging 10 is paper-based and is formed by thermally molding a moldable composition, the moldable composition being 50-70% bamboo fiber, 20-40% sugarcane, and 5-15% wood fiber. In this embodiment, the compostable packaging is composed of about 60% bamboo fiber, about 30% sugarcane, and about 10% wood fiber.

In some embodiments, the main body 20 may contain the granular shampoo composition 40. As shown in FIG. 1, the granular shampoo composition 40 is first poured into the main body 20 of the compostable packaging 10. Then, as shown in FIG. 2, the lid 30 is placed onto the main body 20 to cover the opening 28, wherein the body perimeter 26 and the outer perimeter 32 of the lid 30 are sealed for containing the granular shampoo composition 40 within the compostable packaging 10.

For purposes of this application, the term “granular” is defined to include any form of dry product, grain, powder, or pellet type of material that is not liquid. The term “shampoo” is defined to include shampoo and/or conditioner, body soap, or other similar health and beauty types of products of a similar nature.

In some embodiments, the material contained within the packaging 10 may be in the form of cosmetics (e.g. shampoo, conditioner, body wash, lip balm, skincare, makeup, foundation), medication (e.g. prescription pills, topical medications, vitamins), condiments (e.g. ketchup, mustard, teriyaki, mayonnaise), or other form of products, such as but not limited to coffee, sugar, makeup foundation, lip balm, or any other products which may be used in conjunction with the paper-based composition.

As used in this application, the words “a,” “an,” and “one” are defined to include one or more of the referenced item unless specifically stated otherwise. The terms “approximately” and “about” are defined to mean+/−10%, unless otherwise stated. Also, the terms “have,” “include,” “contain,” and similar terms are defined to mean “comprising” unless specifically stated otherwise. Furthermore, the terminology used in the specification provided above is hereby defined to include similar and/or equivalent terms, and/or alternative embodiments that would be considered obvious to one skilled in the art given the teachings of the present patent application. While the invention has been described with reference to at least one particular embodiment, it is to be clearly understood that the invention is not limited to these embodiments, but rather the scope of the invention is defined by claims made to the invention.

What is claimed is:

1. A compostable packaging comprising:
50-70% bamboo fiber;
20-40% sugarcane; and
5-15% wood fiber.

2. A shampoo product comprising:
a compostable packaging formed by thermally molding a moldable composition, the moldable composition comprising:
50-70% bamboo fiber;
20-40% sugarcane; and
5-15% wood fiber; and
a granular shampoo composition contained within the compostable packaging.

3. The shampoo product of claim 2, wherein the compostable packaging includes a main body that includes a base and an upwardly extending wall that extends to a body perimeter that defines an opening, and further includes a lid that extends to an outer perimeter that sealingly engages the body perimeter for closing the opening of the main body for containing the granular shampoo composition therein.

4. A method for producing a shampoo product, the method comprising the steps of:
providing a moldable composition comprising:
50-70% bamboo fiber;
20-40% sugarcane; and
5-15% wood fiber;
thermally molding the moldable composition into a compostable packaging that includes a main body that includes a base and an upwardly extending wall that extends to a body perimeter that defines an opening, and further includes a lid that extends to an outer perimeter;
pouring a granular shampoo composition into the main body of the compostable packaging;
placing the lid onto the main body to cover the opening; and
sealing the body perimeter and the outer perimeter of the lid for containing the granular shampoo composition within the compostable packaging.
